(19) United States
(12) Patent Application Publication
(10) Pub. No.: US 2007/0003103 A1
(43) Pub. Date: Jan. 4, 2007

(54) Method of allocating optimal payload space

(75) Inventors: Aweke Negash Lemma, Eindhoven (NL); Leon Maria Van De Kerkhof, Eindhoven (NL); Arnoldus Werner Johannes Oomen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,929

(22) PCT Filed: Jan. 13, 2005
(86) PCT No.: PCT/IB05/50145

§ 371 Date: Jun. 29, 2006

(30) Foreign Application Priority Data
Jan. 16, 2004 (EP) 04100132.2

(51) Int. Cl. H04H 1/00; G11B 20/00

(52) U.S. Cl. 382/100; 700/225; 713/100

(57) ABSTRACT

There is provided a method of allocating optimal payload space in a watermarking system. The method includes steps of: (a) obtaining identification parameters relating to programme data content (PC), said identification parameters including at least one or more user identifiers (UID) and one or 5 more programme content identifiers (CID); (b) storing said identification parameters (UID, CID) in one or more databases (30); (c) generating one or more transaction numbers (nTR) capable of being uniquely mapped to corresponding identification parameters (UID, CID) stored in the one or more 10 databases (30); and (d) generating watermark information for carrying said one or more transaction numbers (nTR) and embedding said watermark information as an optimized payload (OPL) into said programme data content (PC) to generate corresponding watermarked data content (WPC).

### FIELD OF THE INVENTION

The present invention relates to methods of allocating optimal payload space, and to an apparatus operable to implement the method. The invention also relates to software executable on computing devices to implement the method.

### BACKGROUND OF THE INVENTION

Producers of audiovisual programme content, for example television broadcasters or advertisers, are often interested in knowing where and when their programme content is distributed. In order to provide such knowledge, broadcast monitoring systems have been developed. In one monitoring system, a watermark is embedded in programme content. The watermark is arranged to include a payload for pointing to a database entry corresponding to the programme content. In use, the watermark is retrieved and employed to identify the content. A problem encountered with such an approach is that a relatively large payload is required when the database is extensive. The large payload is difficult to embed in programme content whilst being substantially imperceptible and unobtrusive.

One known approach to address the above problem is described in a published international PCT patent application no. PCT/EP01/07842 (WO 02/09328). In this published application, there is disclosed a method and arrangement for distributing multimedia content such that actual distribution of the content can be monitored in an efficient and reliable manner. The method combines the effectiveness of feature extraction and the robustness of watermarking. The method concerns extracting characteristic features such as luminance distribution from programme content to constitute a signature (SIG) of the content. Moreover, the method concerns embedding a watermark in the content, the watermark bearing a payload representing an index (ID) in a database in which the programme content to be monitored is stored. The watermark serves as an index for limiting database searching needed for monitoring the signatures.

The inventors have appreciated that there is a certain maximum payload space available in watermarking system when watermarking programme content. Moreover, the inventors have envisaged that it is desirable to employ a method of watermarking which optimally utilizes this payload space. Furthermore, the inventors have appreciated that more efficient use of payload space by using the method of the invention is capable of making available additional space for conveying enhanced features directed towards improving security.

In a specific proprietary development project with which the inventors have been involved, limited watermark payload capacity has been a particular problem. In this project, available watermark payload space in programme content is used to convey transaction information, in particular, content identification (CID) and user identification (UID) and an optional redundancy to improve security. The inventors have identified a problem that allocating a predefined space in the payload for each of these parameters results in very sparse usage of payload space, and sub-optimal use of redundancy within the payload.

### OBJECT AND SUMMARY OF THE INVENTION

An object of the invention is to provide a method of allocating watermarking payload space more optimally. Therefore, the inventors have devised a solution which at least partially addresses the above-mentioned problem.

According to a first aspect of the present invention, there is provided a method of allocating optimal payload space, the method including steps of:
(a) obtaining identification parameters relating to programme data content (PC), said identification parameters including at least one or more user identifiers (UID) and one or more programme content identifiers (CID);
(b) storing said identification parameters (UID, CID) in one or more databases (30);
(c) generating one or more transaction numbers (nTR) capable of being uniquely mapped to corresponding identification parameters (UID, CID) stored in the one or more databases (30); and
(d) generating watermark information for carrying said one or more transaction numbers (nTR) and embedding said watermark information as an optimized payload (OPL) into said programme data content (PC) to generate corresponding watermarked data content (WPC).

The invention is of advantage in that it is capable of offloading data from the payload to the one or more databases, thereby making more payload space available in the watermarked programme content for other payload data, for example security enhancing data.

Preferably, the method further comprises a step of supplying said watermarked programme content (WPC) to one or more users, wherein the one or more transaction numbers (nTR) are capable of being detected in the water marked programme content (WPC) when received by said one or more users for use in accessing corresponding identification parameters (UID, CID) stored in the one or more databases. Inclusion of the one or more transaction numbers in the payload is of benefit in that it circumvents a need to include the corresponding identification parameters within the payload, there by potentially freeing payload capacity for other purposes.

Preferably, in the method, fingerprint information (FP) of the programme content (PC) is stored in the one or more databases (30) together with its associated identification parameters (UID, CID). Such fingerprint information is capable of providing a general impression of the programme content and is therefore of benefit in further validating authenticity of the programme content.

Preferably, in the method, verification of the identification parameters (IUD, CID, FP) with the watermarked programme content (WPC) at the one or more users is implemented as an automatic process without the one or more users needing to intervene.

Preferably, the method includes a further step of identifying whether or not the watermarked programme content (WPC) has been legitimately received by the one or more users by checking whether the received watermarked programme content (WPC) has a payload (OPL) whose transaction number (nTR) invokes identification parameters stored in the one or more databases consistent with the received programme content (WPC). Such checking is of benefit in that it allows for the identification of non-legitimate programme content.

Preferably, in the method, the one or more transaction numbers (nTR) are included in the watermarked programme content (WPC) after being encrypted with an encryption key (K_{PL}). Use of such an encryption key (K_{PL}) is capable of rendering the watermark information more difficult to copy for re-use in watermarking counterfeit or pirate programme content. Thus, such encryption is capable of further deterring counterfeiting and unauthorised programme content copying activities.

Preferably, in the method, the identification parameters (UID, CID) stored in the one or more databases (30) are commonly accessible to a supplier of the programme content (PC) and one or more of the users authorised to access said parameters (UID, CID). Such an arrangement is of benefit in reducing information conveyed in the watermark information applied to the programme content whilst rendering the watermarked data content acceptable to a wider range of users.

Preferably, in the method, the identification parameters are writable into the one or more databases by a supplier of the programme content (PC) and the one or more users are restricted only to reading the identification parameters from the one or more databases. Such accessibility to the one or more databases is capable of deterring pirating and counterfeiting activities by third parties.

According to a second aspect of the invention, there is provided software executable on one or more computing devices for implementing the method of the first aspect of the invention. It will be appreciated that the method is also capable of being implemented substantially in hardware form, for example in the form of a dedicated application specific integrated circuit (ASIC). Such an implementation is of benefit in low-cost consumer products.

According to third aspect of the present invention, there is provided an apparatus for allocating optimal payload space, the apparatus including:
(a) data collecting means for obtaining identification parameters relating to programme data content (PC), said identification parameters including at least one or more user identifiers (UID) and one or more programme content identifiers (CID);
(b) one or more databases for storing said identification parameters (UID, CID);
(c) generating means for generating one or more transaction numbers (nTR) capable of being uniquely mapped to corresponding identification parameters (UID, CID) stored in the one or more databases;
(d) data processing means for generating watermark information carrying said one or more transaction numbers (nTR), and processing means for embedding said watermark information as an optimized payload (OPL) into the programme content (PC) to generate corresponding watermarked programme content (WPC).

According to a fourth aspect of the present invention, there is provided watermarked programme content (WPM) including a watermark whose payload space is allocated optimally according to a method of the first aspect of the invention.

According to a fifth aspect of the invention, there is provided a watermark including a payload whose payload space is allocated optimally according to a method of the first aspect of the invention.

According to a sixth aspect of the present invention, there is provided a method of authenticating watermarked programme content (WPC) whose embedded watermark information includes an optimised payload (OPL) including one or more transaction numbers (nTR) which are mapped, preferably uniquely mapped, to corresponding identification parameters (UID, CID, FP) stored in one or more databases, the method including steps of:
(a) receiving the watermarked programme content (WPC) at one or more authorized users;
(b) extracting watermark information from the received watermarked programme content (WPC);
(c) determining a payload (OPL) included in the watermark information, said payload including one or more transaction numbers (nTR);
(d) using said one or more transaction numbers (nTR) to access corresponding identification parameters from said one or more databases (30), said identification parameters (UID, CID, FP) including a program content fingerprint (FP);
(e) obtaining a locally extracted fingerprint (FPL) of said received watermarked program content (WPC);
(f) checking whether or not said locally extracted fingerprint (FPL) matches said program content fingerprint (FL) obtained from said one or more databases to determine authenticity of the watermarked programme content (WPC).

It will be appreciated that features of the invention are susceptible to being combined in any combination without departing from the scope of the invention.

### DESCRIPTION OF THE DIAGRAMS

Embodiments of the invention will now be described, by way of example only, with reference to the following diagrams wherein:

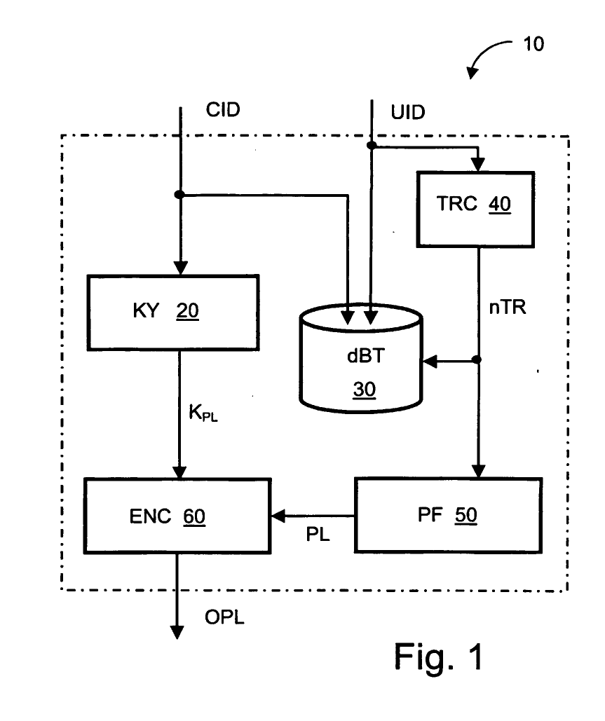

FIG. 1 is a schematic diagram of a payload generator according to the invention for generating watermark payloads whose space has been more optimally used to convey programme content authenticating data;

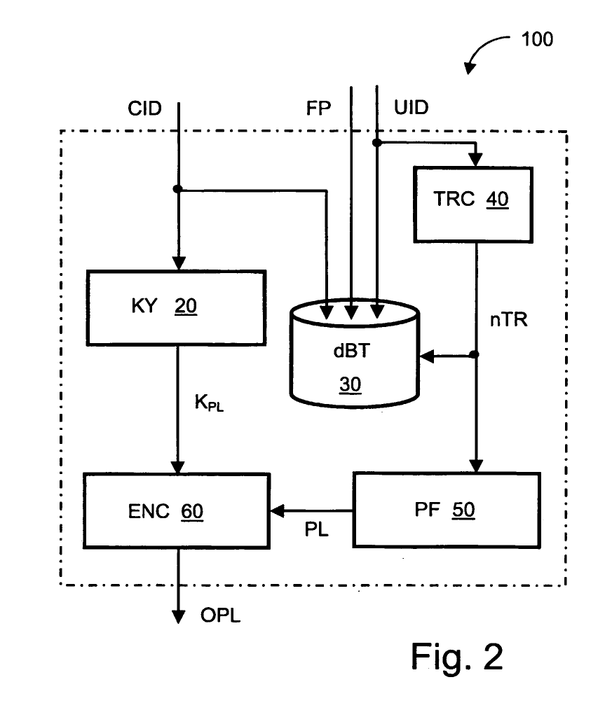

FIG. 2 is a schematic diagram of an alternative payload generator according to the invention adapted to include fingerprint information in its watermark payloads; and

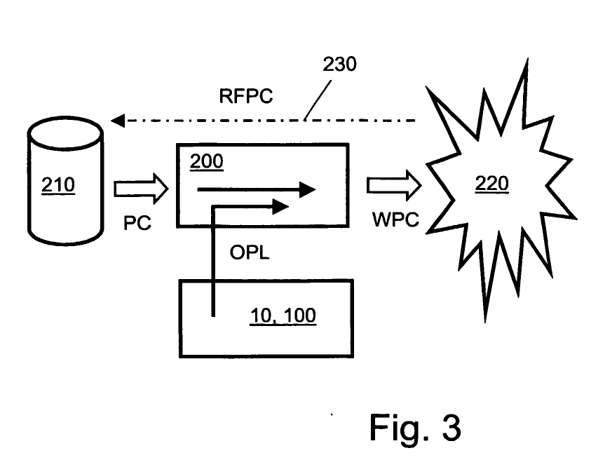

FIG. 3 is an illustration of interaction between the generators of FIGS. 1 and 2 and their associated programme content supplier and user.

### DESCRIPTION OF EMBODIMENTS OF THE INVENTION

In devising an at least partial solution to sparse usage of payload space and sub-optimal use of redundancy, the inventors propose a method of allocating optimal payload space in a watermarking system in which a payload is included in a watermark, the payload being arranged to include a transaction number wherein the transaction number is susceptible to being mapped to actual corresponding transaction parameters such as UID and CID via a commonly accessible table, for example a table stored in a database and accessible to authorized users. The table is preferably capable of being written to by a watermark embedder and being read by a watermark detector. In the detector, the transaction number is initially extracted from the watermark and, by using a unique mapping associating the transaction number to its corresponding CID and UID, the CID and UID are recovered from the table. By employing such a method, an amount of payload space used substantially is equal to the minimum number of bits required to uniquely represent the transactions.

In FIG. 1, there is shown an embodiment of the invention, wherein a payload generator is indicated generally by 10. The generator 10 is operable to receive CID and UID information and to generate a corresponding payload OPL, wherein OPL=FPL(nTR, K_{PL}) namely an encrypted version of a transaction number (nTR) where FPL is representative of encryption applied by an encryption function (ENC) 60 of the generator 10. A key K_{PL} is generated by a key generation function (KY) 20 arranged to receive the CID and subsequently output the key K_{PL}, namely K_{PL}=FKPL(CID). The UID of the user desirous of the programme content corresponding to the CID is passed through a transaction counting function (TRC) 40 to generate the transaction number (nTR). Moreover, the CID together with its related UID and transaction number nTR are stored as a table in a database (dBT) 30 of the generator 10; in other words, tables stored in the database 30 correspond to a set of parameters [nTR, UID, CID]. The generator 10 also includes a payload formatting function (PF) 50 for receiving the transaction number nTR from the counting function TRC 40 and generating a corresponding formatting parameter PL for use in the encryption function ENC 60 when encrypting the transaction number nTR to generate the output payload OPL.

The generator 10 in FIG. 1 is susceptible to being modified to provide a modified generator indicated by 100 in FIG. 2. The generator 100 includes a feature for receiving fingerprinting data (FP) for storage in tables in the database dBT 30, such that a table in the database dBT 30 correspond to a set of parameters [nTR, UID, CID, FP].

The output payload OPL is embedded in the form of watermark information in programme content provided to the user corresponding to UID requesting content from a content provider having one or more of the generators 10, 100. In such a process, programme content provided to a user is uniquely marked so that user is susceptible to being uniquely identifies in an event of the user distributing the content is an unauthorised manner.

The generator 10, or the generator 100, is usable in a capacity as illustrated in FIG. 3. In FIG. 3, the generator 10, 100 is coupled to a watermark embedder 200 for adding watermark content including an optimized payload to programme content distributed from a database 210 to a user 220. Such distribution occurs, for example, by way of a communication network such as the Internet; alternatively, the distribution can alternatively be achieved by way of physical data carrying media, for example magnetically and/or optically readable data carriers such as CD's and DVD's. Preferably, release of the programme content (PC) from the database 210 to the embedder 200 is executed in response to a request (RFPC) 230 from the user 220 for the programme content PC subsequently watermarked (WPC) through the embedder 200 operating in combination with the generator 10, 100, for example in return for payment as consideration for the programme content PC. Optionally, the database 210 and the database dBT 30 of the generator 10, 100 are the same entity.

As an example of use of the generator 10, and similarly the generator 100, a situation arises where four people A-D buy sixteen items PC1-PC16 of programme content as listed in Table 1:

TABLE 1

| Person | Programme content |
|---|---|
| A | PC1 to PC12 |
| B | PC13 |
| C | PC14-15 |
| D | PC16 |

A total number of transactions involved, using the generator 10, 100 in distributing such programme content, is 16 transactions; in other words, 4 binary bits are required to define uniquely each transaction. If separate identifiers were used for the UID and CID, 2 binary bits would be required to represent uniquely the users and 4 binary bits to uniquely define the programme contents, namely a total of 6 binary bits would be required.

During detection at the user 220, a watermark detector thereat initially extracts a payload from the watermarked programme content WPC received thereat. The payload is then decrypted to provide a corresponding transaction number nTR for the programme content. The user 220 then communicates with the database dBT 30 to derive corresponding UID and CID parameters. By such a process, user and content identities can be determined. Any disparity between the identity of the user 220, and the UID and CID on the database dBT 30 is indicative of the user 220 attempting to view copied, pirated or otherwise counterfeit programme content. If required, communication between the user 220 and the databases 30, 210 can be implemented substantially without the user 220 as a person being aware of such transaction occurring.

As elucidated in the forgoing, the generator 100 allows for entry of fingerprint information FP into the payload OPL. Fingerprinting is susceptible to increasing security when watermarked programme content WPC is distributed to users. In an event that a user, for example a counterfeiter, transplants the payload OPL from one programme content to another, the fingerprint information can be used to verify whether or not a given item of programme content corresponds to originally distributed watermarked programme content. Such verification involves extracting a transaction number nTR from programme content and then fingerprint FP information; a check is then made to determine whether or not the extracted fingerprint matches with that stored in the database dBT 30. If the payload is copied from one programme content to another, the extracted fingerprinting FP will not match that stored on the database dBT 30 for that particular programme content PC.

On account of inclusion of the fingerprint FP information, the invention also concerns a method of authenticating watermarked programme content WPC whose embedded watermark information includes an optimised payload OPL including one or more transaction numbers nTR. The transaction parameter are mapped, preferably uniquely mapped, to corresponding identification parameters UID, CID, FP stored in one or more databases. In the authentication method, the watermarked programme content WPC is received at one or more authorized users. Next, the one or more users extract watermark information from the received watermarked programme content WPC and subsequently determine a payload OPL included in the watermark information. The payload includes one or more transaction numbers nTR. The one or more transaction numbers nTR are then useable to access corresponding identification parameters from the one or more databases; the identification parameters UID, CID, FP including a program content fingerprint (FP). Next, the one or more users determine a locally extracted fingerprint (FPL) of the received watermarked program content WPC. Subsequently, the one or more users check whether or not the locally extracted fingerprint FPL matches the said program content fingerprint FP obtained from the said one or more databases. If the two fingerprints FPL, FP substantially match, the watermarked programme content WPC is confirmed to be authentic. Conversely, when there is a substantial difference between the fingerprints FP, FPL, the watermarked programme content WPC is thereby identified as being copied and/or counterfeit.

It will be appreciated that embodiments of the invention described in the foregoing are susceptible to being modified without departing from the scope of the invention as defined by the accompanying claims.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

The invention can be summarized as follows. In Electronic (Music) Delivery systems, a watermark payload should convey data such as Content ID and User ID. However, allocating a predefined space for each of these parameters is suboptimal and requires a large number of bits. To this end, it is proposed to embed a “transaction number” and use a database (writable to embedder, readable to detector) to provide for the mapping between this transaction number and the actual parameters. For example: if 4 persons buy 16 contents, there are 16 transactions which can be represented by in a 4 bit transaction number, whereas individual encoding would require 2 bits to identify the user and 4 bits to identify the content (total 6 bits). In a preferred embodiment, the table also has an entry for fingerprints. This provides additional security in case a malicious user would succeed in transplanting the payload from one content to another. In this system, the detector extracts the fingerprint from the contents and verifies whether the extracted fingerprint matches or not the one stored in the database.

1. A method of allocating payload space, the method including steps of:
(a) obtaining identification parameters relating to programme data content (PC), said identification parameters including at least one or more user identifiers (UID) and one or more programme content identifiers (CID);
(b) storing said identification parameters (UID, CID) in one or more databases (30);
(c) generating one or more transaction numbers (nTR) capable of being uniquely mapped to corresponding identification parameters (UID, CID) stored in the one or more databases (30); and
(d) generating watermark information for carrying said one or more transaction numbers (nTR) and embedding said watermark information as an optimized payload (OPL) into said programme data content (PC) to generate corresponding watermarked data content (WPC).

2. A method according to claim 1, further comprising a step of supplying said watermarked programme content (WPC) to one or more users (220), wherein the one or more transaction numbers (nTR) are capable of being detected in the water marked programme content (WPC) when received by said one or more users (220) for use in accessing corresponding identification parameters (UID, CID) stored in the one or more databases (30).

3. A method according to claim 1, wherein fingerprint information (FP) of the programme content (PC) is stored in the one or more databases (30) together with its associated identification parameters (UID, CID).

4. A method according to claim 1, wherein verification of the identification parameters (IUD, CID, FP) with the watermarked programme content (WPC) at the one or more users (220) is implemented as an automatic process without the one or more users (220) needing to intervene.

5. A method according to claim 1, including a further step of identifying whether or not the watermarked programme content (WPC) has been legitimately received by the one or more users (220) by checking whether the received watermarked programme content (WPC) has a payload (OPL) whose transaction number (nTR) invokes identification parameters stored in the one or more databases (30) consistent with the received programme content (WPC).

6. A method according to claim 1, wherein the one or more transaction numbers (nTR) are included in the watermarked programme content (WPC) after being encrypted with an encryption key (K_{PL}).

7. A method according to claim 1, wherein the identification parameters (UID, CID) stored in the one or more databases (30) are commonly accessible to a supplier of the programme content (PC) and one or more of the users (220) authorised to access said parameters (UID, CID).

8. A method according to claim 1, wherein the identification parameters are writable into the one or more databases (30) by a supplier of the programme content (PC) and the one or more users (220) are restricted only to reading the identification parameters from the one or more databases (30).

9. Watermarked programme content (WPM) including a watermark whose payload space is allocated optimally according to a method of claim 1.

10. A watermark including a payload whose payload space is allocated optimally according to a method of claim 1.

11. Software executable on one or more computing devices for implementing the method of claim 1.

12. An apparatus (10, 100) for allocating payload space, the apparatus (10, 100) including:
(a) data collecting means for obtaining identification parameters relating to programme data content (PC), said identification parameters including at least one or more user identifiers (UID) and one or more programme content identifiers (CID);
(b) one or more databases (30) for storing said identification parameters (UID, CID);
(c) generating means for generating one or more transaction numbers (nTR) capable of being uniquely mapped to corresponding identification parameters (UID, CID) stored in the one or more databases (30);
(d) data processing means for generating watermark information carrying said one or more transaction numbers (nTR), and processing means for embedding said watermark information as an optimized payload (OPL) into the programme content (PC) to generate corresponding watermarked programme content (WPC).

13. A method of authenticating watermarked programme content (WPC) whose embedded watermark information includes an optimised payload (OPL) including one or more transaction numbers (nTR) which are mapped; preferably uniquely mapped, to corresponding identification parameters (UID, CID, FP) stored in one or more databases, the method including steps of:
(a) receiving the watermarked programme content (WPC) at one or more authorized users;
(b) extracting watermark information from the received watermarked programme content (WPC);
(c) determining a payload (OPL) included in the watermark information, said payload including one or more transaction numbers (nTR);
(d) using said one or more transaction numbers (nTR) to access corresponding identification parameters from said one or more databases (30), said identification parameters (UID, CID, FP) including a program content fingerprint (FP);
(e) obtaining a locally extracted fingerprint (FPL) of said received watermarked program content (WPC);
(f) checking whether or not said locally extracted fingerprint (FPL) matches said program content fingerprint (FL) obtained from said one or more databases (30) to determine authenticity of the watermarked programme content (WPC).
